(19) United States
(12) Patent Application Publication
(10) Pub. No.: US 2025/0163308 A1
(43) Pub. Date: May 22, 2025

(54) EPOXY CURATIVE COMPOSITIONS AND METHODS OF USING THE SAME

(71) Applicant: UNIVAR SOLUTIONS LLC, Downers Grove, IL (US)

(72) Inventors: Ralph BARTHEL, Downers Grove, IL (US); Bobby PICKER, Downers Grove, IL (US); Ali KIAN, Downers Grove, IL (US)

(73) Assignee: UNIVAR SOLUTIONS LLC, Downers Grove, IL (US)

(21) Appl. No.: 18/953,567

(22) Filed: Nov. 20, 2024

Related U.S. Application Data
(60) Provisional application No. 63/601,407, filed on Nov. 21, 2023.

(51) Int. Cl. C09J 183/08; B32B 37/12; C09J 5/00; C09J 11/04

(52) U.S. Cl. CPC C09J 183/08; B32B 37/12; C09J 5/00; C09J 11/04; B32B 2037/1253; B32B 2363/00; B32B 2383/00

(57) ABSTRACT

The present disclosure provides bonding and/or coating compositions including various components. Also provided are methods of using the compositions for bonding and/or coating surfaces. Certain components of the bonding and/or coating compositions include, but are not limited to, a liquid diamino silicone resin, a multi-functional amine, an epoxy resin, and fumed silica. The bonding and/or coating compositions, or the components thereof, may be applied to a dry surface or a wet surface, such as a surface submerged under water.

### TECHNICAL FIELD

The present disclosure generally relates to compositions and methods for bonding. More particularly, the disclosure provides epoxy resin compositions and methods of using the compositions for bonding and/or coating various surfaces and/or substrates.

### BACKGROUND

Epoxy resins are widely used for their strong and durable adhesion between surfaces. The components of the resins are mixed before application to a surface with one component containing an epoxide-functionalized resin and another component containing a nucleophile for hardening and polymerization. The nucleophile in the hardening component is generally an amine compound that reacts with the epoxy functionality to create a durable polyamide polymer.

One challenge for epoxy resins is their use underwater. Using epoxy resins in wet conditions has shown to have several drawbacks. Epoxy resins often suffer from decreased binding to a wet surface as well as increased hardening or curing time. Using epoxy resin underwater may also change the nature of the hardening reaction as water is also a nucleophile. Finally, many epoxy resins undergo a certain degree of leaching, which has implications for biological toxicity.

### BRIEF SUMMARY

The present disclosure provides epoxy curative compositions and methods of using the same for adhesion. It should be understood that in certain aspects of the present disclosure, the terms “adhesive,” “adhesion,” and the like may be substituted with the term “coating,” “coat,” and the like. For example, if a section of the present disclosure refers to methods of using the presently disclosed compositions for adhesion, it is to be understood that the section also covers methods of using the presently disclosed compositions for coating.

In some embodiments, a composition of the present disclosure includes a liquid diamino silicone resin, a multi-functional amine, an epoxy resin, and fumed silica.

In some embodiments, a method of the present disclosure includes applying a liquid diamino silicone resin, a multi-functional amine, an epoxy resin, and fumed silica to a surface.

The foregoing has outlined rather broadly the features and technical advantages of the present disclosure in order that the detailed description that follows may be better understood. Additional features and advantages of the disclosure will be described hereinafter that form the subject of the claims of this application.

### DETAILED DESCRIPTION

Various embodiments are described below. The relationship and functioning of the various elements of the embodiments may better be understood by reference to the following detailed description. However, embodiments are not strictly limited to those described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

As used herein the term “primary amine” means the unit —NH₂. As used herein the term “secondary amine” means the unit —NHR₂ where R₂ may be, for example, a hydrocarbyl group, such as a C₁₋₆ alkyl group. A “tertiary amine” refers to the unit —N(R₂)₂ where each R₂ may independently be, for example, a hydrocarbyl group, such as a C₁₋₆ alkyl group.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(RA)(RB), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

As used herein, the term “epoxy resin” means a polymer containing generally two or more epoxide groups per molecule.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

### Compositions

The compositions, mixtures, and/or blends disclosed herein may include various compounds and/or components and may be used for treating surfaces, repairing damaged surfaces, bonding two or more surfaces together, etc. The compositions, mixtures, and/or blends may be applied to the surface(s) when the surface is dry or if the surface is wet. For example, the compositions, mixtures, and/or blends may be applied to a surface when the surface is submerged under water. As is more fully discussed below, the compositions, mixtures, and/or blends disclosed herein have little or no organic leaching underwater, which is a significant advantage over the prior art.

Although the following detailed description may refer to various compositions, it is to be understood that the term “composition” is used interchangeably with the terms “mixture” and “blend”.

The compositions disclosed herein may include a liquid silicone resin, such as a liquid diamino silicone resin. The liquid silicone resin may include, for example, a siloxane, a silicone, 3-aminopropyl methyl siloxane, a diphenyl siloxane, a polymer with a phenyl silsesquioxane, and any combination thereof. In an illustrative, non-limiting embodiment, the liquid silicone resin may comprise the composition of CAS Registry Number 1242619-23-3.

Certain liquid silicone resins disclosed herein have an amine equivalent weight from about 1 g/mol to about 450 g/mol, such as from about 1 g/mol to about 400 g/mol, about 1 g/mol to about 350 g/mol, about 1 g/mol to about 300 g/mol, about 1 g/mol to about 250 g/mol, about 100 g/mol to about 400 g/mol, about 100 g/mol to about 300 g/mol, about 200 g/mol to about 300 g/mol, about 220 g/mol, about 240 g/mol, about 260 g/mol, or about 280 g/mol.

The amount of the liquid silicone resin in the composition is not particularly limited and may be selected depending upon, for example, the intended use of the composition. In certain aspects, the composition may comprise from about 50 wt. % to about 99 wt. % of the liquid silicone resin, such as from about 50 wt. % to about 95 wt. %, about 50 wt. % to about 90 wt. %, about 50 wt. % to about 85 wt. %, about 50 wt. % to about 80 wt. %, about 50 wt. % to about 75 wt. %, about 50 wt. % to about 70 wt. %, about 60 wt. % to about 85 wt. %, about 60 wt. % to about 90 wt. %, about 60 wt. % to about 95 wt. %, about 65 wt. % to about 95 wt. %, about 65 wt. % to about 85 wt. %, about 70 wt. % to about 95 wt. %, about 70 wt. % to about 90 wt. %, about 70 wt. % to about 85 wt. %, about 75 wt. % to about 85 wt. %, about 76 wt. %, about 77 wt. %, about 78 wt. %, about 79 wt. %, about 80 wt. %, about 81 wt. %, about 82 wt. %, about 83 wt. %, about 84 wt. %, or about 85 wt. % of the liquid silicone resin.

The compositions disclosed herein may also include a multi-functional amine compound, such as a di-functional or tri-functional amine compound. The multi-functional amine compound may comprise a primary amine, a secondary amine, and/or a tertiary amine. In some embodiments, the multi-functional amine compound is a multi-functional primary amine. In some embodiments, the multi-functional amine compound comprises a mixture of primary and secondary amine-containing compounds. Illustrative, non-limiting examples of multi-functional amine compounds include 4-aminomethyl-1,8-octanediamine, diethylenetriamine (DETA-CAS Registry Number 111-40-0), triethylenetetraamine (TETA-CAS Registry Number 112-24-3), tetraethylenepentamine (TEPA-CAS Registry Number 112-57-2), and any combination thereof. In certain aspects, the multi-functional amine may comprise the composition of CAS Registry Number 1572-55-0.

The compositions of the present disclosure may comprise, for example, from about 1 wt. % to about 25 wt. % of the multi-functional amine, such as from about 1 wt. % to about 20 wt. %, about 1 wt. % to about 15 wt. %, about 1 wt. % to about 10 wt. %, about 1 wt. % to about 5 wt. %, about 5 wt. % to about 25 wt. %, about 5 wt. % to about 20 wt. %, about 5 wt. % to about 15 wt. %, about 5 wt. % to about 10 wt. %, about 6 wt. %, about 7 wt. %, about 8 wt. %, or about 9 wt. % of the multi-functional amine.

The compositions of the present disclosure may also include an epoxy resin, which may be a liquid epoxy resin, a solid epoxy resin, or a combination thereof. Illustrative, non-limiting examples of liquid epoxy resins include bisphenol A diglycidyl ether resin, a bisphenol F diglycidyl ether resin, a bisphenol A epichlorohydrin resin, a bisphenol F epichlorohydrin resin, and any combination thereof. In certain aspects, the liquid epoxy resin may comprise the composition of CAS Registry Number 25085-99-8.

As additional examples, the liquid epoxy resin component may comprise an aliphatic multi-amino functionality amine, such as TETA and/or DETA. Further, the liquid epoxy resin component may include any liquid epoxy grade with either Bis A or Bis F, novalacs, or any combination thereof. In certain embodiments, the epoxy resin component may be a solid, such as a type I-VII solid epoxy resin.

The compositions of the present disclosure may comprise, for example, from about 1 wt. % to about 15 wt. % of the epoxy resin, such as from about 1 wt. % to about 12 wt. %, about 1 wt. % to about 10 wt. %, about 1 wt. % to about 7 wt. %, about 1 wt. % to about 5 wt. %, about 3 wt. % to about 15 wt. %, about 3 wt. % to about 12 wt. %, about 3 wt. % to about 10 wt. %, about 5 wt. % to about 10 wt. %, about 3 wt. %, about 4 wt. %, about 5 wt. %, about 6 wt. %, about 7 wt. %, or about 8 wt. % of the epoxy resin.

The compositions of the present disclosure may also comprise fumed silica. Illustrative, non-limiting examples include methylated silica, silicon dioxide, synthetic amorphous silica, pyrogenic amorphous silica, colloidal silicon dioxide, and any combination thereof. In certain aspects, the fumed silica may comprise the composition of CAS Registry Number 67762-90-7.

The fumed silica may be untreated but it may also be treated, such as polydimethylsiloxane treated fumed silica

The compositions may comprise, for example, from about 1 wt. % to about 15 wt. % of the fumed silica, such as from about 1 wt. % to about 12 wt. %, about 1 wt. % to about 10 wt. %, about 1 wt. % to about 7 wt. %, about 1 wt. % to about 5 wt. %, about 3 wt. % to about 15 wt. %, about 3 wt. % to about 12 wt. %, about 3 wt. % to about 10 wt. %, about 5 wt. % to about 10 wt. %, about 3 wt. %, about 4 wt. %, about 5 wt. %, about 6 wt. %, about 7 wt. %, or about 8 wt. % of the fumed silica.

### Methodology

The present disclosure also provides methods of using the compositions disclosed herein for treating surfaces, repairing damaged surfaces, bonding two or more surfaces together, coating a surface, etc. The compositions may be applied to the surface(s) when the surface is dry and/or if the surface is wet. For example, the composition may be applied to a surface when the surface is submerged under water.

In some embodiments, the surface may be cleaned/degreased before application of any of the compositions, compounds, and/or components disclosed herein by using any method known in the art, such as through the use of chemical cleaning agents and/or mechanical force (e.g., scraping, wiping, buffing, acid-etching, etc.). For example, if a surface comprises algae, the algae may be removed before application of any of the compositions, compounds, and/or components disclosed herein.

The components of the compositions disclosed herein may be applied to the surface individually, together, or in any combination or mixture. For example, the liquid diamino silicone resin may be mixed with the multi-functional amine to form a first mixture and the epoxy resin may be added to the first mixture to form a second mixture. The second mixture may be blended, for example, to obtain a uniform composition. After blending, the fumed silica may be added to the second mixture to form a third mixture and the third mixture may be blended, for example, to obtain a uniform composition. After blending, the third mixture may be heated, such as to about 50° C., about 55° C., about 60° C., or about 65° C., for about 2 hours to about 24 hours (or more), such as about 6, about 8, about 10, or about 12 hours. This allows the epoxy to form the adduct with the various amines in the composition. This represents the curative portion of the adhesive disclosed herein.

As an additional example, the liquid diamino silicone resin may be mixed with the epoxy resin to form a first mixture. In a separate reaction vessel, the multi-functional amine may be mixed with an epoxy resin to form a second mixture. The first and second mixtures may then be blended together, along with fumed silica, to form the curative. Optionally, after blending, the curative may be heated, such as to about 50° C., about 55° C., about 60° C., or about 65° C., for about 2 hours to about 24 hours (or more), such as about 6, about 8, about 10, or about 12 hours.

The amount of each component in each mixture/blend is not particularly limited.

As an illustrative example, the first mixture may comprise from about 0.5 wt. % to about 10 wt. % of the epoxy resin, such as from about 0.5 wt. % to about 8 wt. %, about 0.5 wt. % to about 6 wt. %, about 0.5 wt. % to about 4 wt. %, about 1 wt. % to about 4 wt. %, about 2 wt. % to about 4 wt. %, about 2 wt. % to about 3 wt. %, or about 2.5 wt. %.

The first mixture may also comprise, in an illustrative example, from about 99.5 wt. % to about 90 wt. % of the liquid diamino silicone resin, such as about 99.5 wt. % to about 92 wt. %, 99.5 wt. % to about 94 wt. %, 99.5 wt. % to about 96 wt. %, about 99 wt. % to about 96 wt. %, about 98 wt. % to about 96 wt. %, about 98 wt. % to about 97 wt. %, or about 97.5 wt. %.

In an illustrative example, the second mixture may comprise from about 1 wt. % to about 20 wt. % of the epoxy resin, such as from about 1 wt. % to about 18 wt. %, about 1 wt. % to about 16 wt. %, about 1 wt. % to about 14 wt. %, about 1 wt. % to about 12 wt. %, about 1 wt. % to about 10 wt. %, about 1 wt. % to about 8 wt. %, about 1 wt. % to about 6 wt. %, about 3 wt. % to about 20 wt. %, about 5 wt. % to about 20 wt. %, about 7 wt. % to about 20 wt. %, about 9 wt. % to about 20 wt. %, about 11 wt. % to about 20 wt. %, about 13 wt. % to about 20 wt. %, about 15 wt. % to about 20 wt. %, about 6 wt. % to about 14 wt. %, about 8 wt. % to about 12 wt. %, or about 12 wt. %.

The second mixture may also comprise, in an illustrative example, from about 99 wt. % to about 80 wt. % of the multi-functional amine, such as about 99 wt. % to about 82 wt. %, 99 wt. % to about 84 wt. %, 99 wt. % to about 86 wt. %, about 99 wt. % to about 88 wt. %, about 99 wt. % to about 90 wt. %, about 99 wt. % to about 92 wt. %, about 97 wt. % to about 80 wt. %, about 95 wt. % to about 80 wt. %, about 93 wt. % to about 80 wt. %, about 91 wt. % to about 80 wt. %, about 89 wt. % to about 80 wt. %, about 94 wt. % to about 86 wt. %, about 92 wt. % to about 88 wt. %, or about 90 wt. %.

The curative may comprise any amounts of the first mixture, the second mixture, and the fumed silica.

For example, the curative may comprise from about 1 wt. % to about 99 wt. % of the first mixture, such as from about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 10 wt. %, about 1 wt. % to about 5 wt. %, about 10 wt. % to about 99 wt. %, about 20 wt. % to about 99 wt. %, about 30 wt. % to about 99 wt. %, about 40 wt. % to about 99 wt. %, about 50 wt. % to about 99 wt. %, about 60 wt. % to about 99 wt. %, about 70 wt. % to about 99 wt. %, about 80 wt. % to about 99 wt. %, about 90 wt. % to about 99 wt. %, about 92 wt. % to about 97 wt. %, or about 94 wt. % to about 96 wt. %.

Additionally, the curative may comprise from about 1 wt. % to about 99 wt. % of the second mixture, such as from about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 20 wt. %, about 1 wt. % to about 10 wt. %, about 2 wt. % to about 8 wt. %, about 3 wt. % to about 7 wt. %, or about 4 wt. % to about 6 wt. %.

Further, the curative may comprise from about 1 wt. % to about 99 wt. % of the fumed silica, such as from about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 20 wt. %, about 1 wt. % to about 10 wt. %, about 2 wt. % to about 9 wt. %, about 4 wt. % to about 9 wt. %, about 6 wt. % to about 9 wt. %, or about 7 wt. % to about 8 wt. %.

In some embodiments, the curative comprises a greater amount of the liquid diamino silicone resin than the multi-functional amine. The inventors unexpectedly discovered that a curative with more liquid diamino silicone resin than multi-functional amine provided an adhesive composition with improved adhesive strength.

In some embodiments, the curative comprises a greater amount of the multi-functional amine than the epoxy resin. The inventors unexpectedly discovered that a curative with more multi-functional amine than epoxy resin provided an adhesive composition with improved washout resistance.

To prepare the adhesive composition, the curative disclosed herein may be blended at the appropriate stoichiometric ratio with an epoxy resin component, which may be any epoxy resin disclosed in the present application and can be the same or different as the epoxy resin used to form the curative.

In some embodiments, the adhesive composition may comprise from about 1 wt. % to about 99 wt. % of the curative, such as from about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 10 wt. %, about 1 wt. % to about 5 wt. %, about 10 wt. % to about 99 wt. %, about 20 wt. % to about 99 wt. %, about 30 wt. % to about 99 wt. %, about 40 wt. % to about 99 wt. %, about 50 wt. % to about 99 wt. %, about 60 wt. % to about 99 wt. %, about 70 wt. % to about 99 wt. %, about 80 wt. % to about 99 wt. %, about 90 wt. % to about 99 wt. %, about 25 wt. % to about 75 wt. %, or about 40 wt. % to about 60 wt. %.

The adhesive composition may comprise, for example, from about 1 wt. % to about 99 wt. % of the epoxy resin component, such as from about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 10 wt. %, about 1 wt. % to about 5 wt. %, about 10 wt. % to about 99 wt. %, about 20 wt. % to about 99 wt. %, about 30 wt. % to about 99 wt. %, about 40 wt. % to about 99 wt. %, about 50 wt. % to about 99 wt. %, about 60 wt. % to about 99 wt. %, about 70 wt. % to about 99 wt. %, about 80 wt. % to about 99 wt. %, about 90 wt. % to about 99 wt. %, about 25 wt. % to about 75 wt. %, or about 40 wt. % to about 60 wt. %.

Once adequately mixed (e.g., hand mixed or mixed with an appropriate static mixer and two-component syringe), the adhesive composition may be applied to the surface(s) to be bonded. Curing may take place at a variety of temperatures. For example, curing may be carried out at about 5° C. to about 80° C., such as about 10° C., about 20° C., about 30° C., about 40° C., about 50° C., about 60° C., or about 70° C.

A significant advantage of the presently disclosed adhesive composition is that it may be cured at a wide range of temperatures, including lower temperatures, such as temperatures of about 10° C., about 5° C., or lower.

The curing time can vary anywhere from a few minutes, such as about 5, about 10, about 15, about 20, about 25, or about 30 minutes, to a few hours, such as about 2 hours, about 5 hours, about 10 hours, about 15 hours, about 20 hours, or about 24 hours, about 48 hours, about 72 hours, or more.

In certain embodiments, a second surface may be disposed on the composition before all components of the composition have cured so that when the composition cures, the second surface is bonded to the first surface. The compositions of the present disclosure may be used to bond any number of surfaces together.

The surface of the present disclosure is not limited, may be from any industry, and may be formed from any type of materials. In some embodiments, a bridge or a pier may comprise the surface. For example, the composition of the present disclosure may be used to wrap existing underwater components with composite fabrics (e.g., carbon fiber) and the composition may cure underwater. This could also extend to oil and gas floating structures (wooden or metal piers with a hydrophobic carbon composite wrap). Additionally, the compositions of the present disclosure could be injected as a filler/reinforcing composite for wooden piers, which could be an improved method to repair a damaged pier.

In certain embodiments, military equipment may comprise the surface of the present disclosure. For example, the compositions disclosed herein could be applied to a military ship under the water, above the water, or a combination thereof. The methods and compositions of the present disclosure are similarly applicable to any civilian watercraft.

As an additional illustrative example, the surface of the present disclosure may be located on equipment used in the mining industry where harsh environments with high humidity are typically encountered.

The components and/or compositions disclosed herein may be applied to a surface when the surface is dry, wet, submerged under water, etc. In certain aspects, certain components may be applied when the surface is dry and other components may be subsequently applied when the surface has been submerged under water. In other aspects, all components of the composition may be applied when the surface is dry or all components of the composition may be applied when the surface is wet and/or submerged under water. The water may comprise, for example, fresh water, salt water, and/or chlorinated water.

Without wishing to be bound by theory, the liquid epoxy resin may polymerize through a reaction between the bisphenol compound and an amine. Unreacted bisphenol compound may migrate into an aqueous environment surrounding the surface, thereby causing undesirable “washout” of that component. Other components and/or reaction products of components may be susceptible to leaching out into the aqueous environment. However, the present inventors unexpectedly discovered that certain orders of addition of the components disclosed herein effectively reduce or substantially prevent the undesired washout/leaching. For example, after all components have been added and the composition has been cured, no components, such as organic components, are released from the composition into the environment surrounding the surface.

The compositions and/or components may be applied by any means known in the art. For example, the compositions and/or components may be applied using a static mixer, such as a pressurized plunger/mix system. An illustrative, non-limiting example includes the 3M EPX Plus II Applicator.

The foregoing may be better understood by reference to the following examples, which are intended for illustrative purposes and are not intended to limit the scope of the disclosure or its application in any way.

### Examples

Lap-shear testing was conducted according to ASTM D1002, the steps of which are hereby incorporated by reference into the present application in their entirety, using an Instron model 5965. Pull-off Adhesion testing was conducted using a DeFelsko PosiTestAdhesion Tester and dollies glued to the surface of the concrete with tested adhesive. The test area was isolated by cutting through the adhesive squeeze out surrounding the dolly down to the substrate. Pressure was applied to the dolly until the dolly was removed or the pressure limit was reached. The mode of failure was recorded along with the pressure at break in PSI.

Formula I was tested in a first set of experiments. Formula I included:
about 83 wt. % of the liquid diamino silicone resin,
about 7 wt. % of the multi-functional amine,
about 6 wt. % of the epoxy resin, and
about 4 wt. % of the fumed silica.

In accordance with certain tests conducted by the inventors, the curative was produced by blending the liquid diamino silicone resin, the multi-functional amine, the epoxy resin, and the fumed silica together. The mixture was then heated to about 60° C. for about 12 hours.

Formula I was tested against a competitive epoxy curative, which was a modified aliphatic polyamine curing agent, using the pull-off adhesion test and data was taken after 2 days, 13 days, and 8 weeks under water.

A direct comparison of Formula I against the competitive curative showed that Formula I outperformed the competitive curative. Concrete blocks were submerged in tap water for 24 hours and remained covered by at least an inch of water. Both adhesives were applied to pull-off test dollies and immediately submerged in the water and glued to concrete blocks. The standard pull-off adhesion test was conducted after 2 days submerged, 13 days submerged, and 8 weeks submerged.

After 2 days, Formula I showed 100% concrete failure at 396 PSI. The competitive curative showed 100% adhesive failure at 179 PSI. Complete substrate failure, concrete failure in this case, it the best outcome. The adhesive is stronger than the substrate. The 396 PSI indicates the strength needed to break the concrete. Complete adhesive failure shows that the substrate is stronger than the adhesive. The adhesive could only withstand 179 PSI before it pulled off of the concrete.

After 13 days submerged, similar results were obtained. Formula I again showed complete concrete failure at 300 PSI while the competitive curative again showed complete adhesive failure at 50 PSI.

After 8 weeks submerged, similar results were obtained. Formula I showed 96% concrete failure with 4% adhesive failure at 355 PSI. The small amount of adhesive failure at 8 weeks submerged is insignificant. The competitive curative showed complete adhesive failure at 18 PSI.

The same tests were carried out with Formula II, which included:
about 81 wt. % of the liquid diamino silicone resin
about 7 wt. % of the multi-functional amine
about 6 wt. % of the epoxy resin
about 6 wt. % of the fumed silica

In accordance with certain tests conducted by the inventors, the curative was produced by blending the liquid diamino silicone resin, the multi-functional amine, the epoxy resin, and the fumed silica until a uniform mixture was obtained. The mixture was then heated to about 60° C. for about 12 hours.

After about 2 days, a dolly comprising Formula II showed 188 PSI with 100% cohesive concrete failure.

Another issue encountered in the field may be referred to as “washout,” which refers to materials, such as an organic component (e.g., adhesive), that float to the surface of the water and typically form an unwanted film on the surface of the water. While the washout issue is encountered with many prior art compositions, some of which have superior adhesion properties, Formulations I & II proved to have no washout during testing while still providing superior adhesion properties.

Additional stress tests were conducted with compositions of the present disclosure as well as comparative compositions. The stress conditions were as follows:

Cure for 3 days at ambient temperature under tap water, boil for 4 hours, recover at ambient temperature for 4 hours, then test adhesion.

Cure for 3 days at ambient temperature under tap water, freeze overnight, recover to ambient temperature for 4 hours, then test adhesion.

Cure for 3 days at 5° C. under tap water, recover to ambient temperature for 4 hours, then test adhesion.

Cure for 3 days at 50° C. under tap water, recover to ambient temperature for 4 hours, then test adhesion.

Cure for 3 days at ambient temperature in salt water (5% NaCl), then test adhesion.

Cure for 3 days at ambient temperature in swimming pool water (about 4 ppm chlorine), then test adhesion.

The following Tables show the results of the tests.

TABLE 1
Pool Water for 3 Days

Failure Mode

| Formula | PSI | Concrete | Adhesive |
|---|---|---|---|
| Inventive | 569 | 100% | 0% |
| Adhesive | | | |
| Composition | | | |
| Inventive | 575 | 100% | 0% |
| Adhesive | | | |
| Composition | | | |
| Commercial | 369 | 100% | 0% |
| Product | | | |
| Commercial | 416 | 100% | 0% |
| Product | | | |

TABLE 2
Salt Water for 3 Days

Failure Mode

| Formula | PSI | Concrete | Adhesive |
|---|---|---|---|
| Inventive | 587 | 100% | 0% |
| Adhesive | | | |
| Composition | | | |
| Inventive | 550 | 100% | 0% |
| Adhesive | | | |
| Composition | | | |
| Commercial | 599 | 100% | 0% |
| Product | | | |
| Commercial | 565 | 100% | 0% |
| Product | | | |

TABLE 3
Standard Tap Water for 3 Days

Failure Mode

| Formula | PSI | Concrete | Adhesive |
|---|---|---|---|
| Inventive | 737 | 100% | 0% |
| Adhesive | | | |
| Composition | | | |
| Inventive | 640 | 100% | 0% |
| Adhesive | | | |
| Composition | | | |
| Commercial | 481 | 100% | 0% |
| Product | | | |
| Commercial | 421 | 100% | 0% |
| Product | | | |

TABLE 4
Standard Tap Water at 50° C. for 3 Days

Failure Mode

| Formula | PSI | Concrete | Adhesive |
|---|---|---|---|
| Inventive | 475 | 100% | 0% |
| Adhesive | | | |
| Composition | | | |
| Inventive | 407 | 100% | 0% |
| Adhesive | | | |
| Composition | | | |
| Commercial | 586 | 100% | 0% |
| Product | | | |
| Commercial | 210 | 100% | 0% |
| Product | | | |

TABLE 5
Standard Tap Water at 5° C. for 3 Days

Failure Mode

| Formula | PSI | Concrete | Adhesive |
|---|---|---|---|
| Inventive | 654 | 100% | 0% |
| Adhesive | | | |
| Composition | | | |
| Inventive | 581 | 100% | 0% |
| Adhesive | | | |
| Composition | | | |
| Commercial | 305 | 10% | 90% |
| Product | | | |
| Commercial | 435 | 100% | 0% |
| Product | | | |

TABLE 6
Standard Tap Water for 3 Days then Boiled for 4 Hours

Failure Mode

| Formula | PSI | Concrete | Adhesive |
|---|---|---|---|
| Inventive | 471 | 100% | 0% |
| Adhesive | | | |
| Composition | | | |
| Inventive | 295 | 100% | 0% |
| Adhesive | | | |
| Composition | | | |
| Commercial | 555 | 100% | 0% |
| Product | | | |
| Commercial | 453 | 100% | 0% |
| Product | | | |

TABLE 7
Standard Tap Water for 3 Days then Frozen Overnight

Failure Mode

| Formula | PSI | Concrete | Adhesive |
|---|---|---|---|
| Inventive | 536 | 100% | 0% |
| Adhesive | | | |
| Composition | | | |
| Inventive | 390 | 30% | 70% |
| Adhesive | | | |
| Composition | | | |
| Commercial | 631 | 100% | 0% |
| Product | | | |
| Commercial | 539 | 100% | 0% |
| Product | | | |

TABLE 8
Standard Tap Water at 50° C. for 3 Days, Repeated

Failure Mode

| Formula | PSI | Concrete | Adhesive |
|---|---|---|---|
| Inventive | 473 | 100% | 0% |
| Adhesive | | | |
| Composition | | | |
| Inventive | 475 | 100% | 0% |
| Adhesive | | | |
| Composition | | | |
| Commercial | 570 | 100% | 0% |
| Product | | | |
| Commercial | 539 | 100% | 0% |
| Product | | | |

TABLE 9
Standard Tap Water at 5° C. for 3 Days, Repeated

Failure Mode

| Formula | PSI | Concrete | Adhesive |
|---|---|---|---|
| Inventive | 502 | 100% | 0% |
| Adhesive | | | |
| Composition | | | |
| Inventive | 463 | 100% | 0% |
| Adhesive | | | |
| Composition | | | |
| Commercial | 352 | 80% | 20% |
| Product | | | |
| Commercial | 373 | 80% | 20% |
| Product | | | |

The “commercial product” included various components, such as a Mannich base amine, an aliphatic amine, barium sulfate, and sand.

The “inventive adhesive composition” included about 80 to about 88 wt. % of the liquid diamino silicone resin, about 2 to about 7 wt. % of the multi-functional amine, about 2 to about 7 wt. % of the epoxy resin, and about 5 to about 10 wt. % of the fumed silica.

The two results in each Table for the commercial product and the inventive adhesive composition are the result of replication with the dolly testing.

As can be seen, the inventive curative of the present disclosure performed as well as, if not better than, the commercial product when cured at ambient temperature under tap water for 3 days. Running the same test at 5° C. shows that the commercial product has some weakness. Three of the four samples tested showed less than 100% concrete failure. Running the test for 3 days at ambient temperature then freezing overnight gave some variability. Overall, the inventive curative performed as good as, if not better than, the commercial product.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a primary amine” is intended to include “at least one primary amine” or “one or more primary amines.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A composition, comprising:
a liquid diamino silicone resin,
a multi-functional amine,
an epoxy resin, and
fumed silica.

2. The composition of claim 1, wherein the composition comprises from about 65 wt. % to about 95 wt. % of the liquid silicone resin, from about 1 wt. % to about 20 wt. % of the multi-functional amine, from about 1 wt. % to about 15 wt. % of the epoxy resin, and/or from about 1 wt. % to about 15 wt. % of the fumed silica.

3. The composition of claim 1, wherein the liquid silicone resin is an amino-functional methyl silicone resin.

4. The composition of claim 1, wherein the multi-functional amine is selected from the group consisting of 4-aminomethyl-1,8-octanediamine, diethylenetriamine (DETA), triethylenetetraamine (TETA), tetraethylenepentamine (TEPA), and any combination thereof.

5. The composition of claim 1, wherein the epoxy resin is selected from the group consisting of a bisphenol A diglycidyl ether resin, a bisphenol F diglycidyl ether resin, a bisphenol A epichlorohydrin resin, a bisphenol F epichlorohydrin resin, and any combination thereof.

6. The composition of claim 1, wherein the fumed silica is selected from the group consisting of methylated silica, silicon dioxide, synthetic amorphous silica, pyrogenic amorphous silica, colloidal silicon dioxide, and any combination thereof.

7. The composition of claim 1, wherein an amine equivalent weight of the liquid silicone resin is from about 1 g/mol to about 450 g/mol.

8. The composition of claim 1, wherein the composition excludes a Mannich base.

9. A method, comprising:
applying a liquid diamino silicone resin, a multi-functional amine, an epoxy resin, and fumed silica to a surface.

10. The method of claim 9, wherein the liquid diamino silicone resin, the multi-functional amine, the epoxy resin, and the fumed silica are applied to the surface individually in any order or as one or more mixtures.

11. The method of claim 9, further comprising mixing the liquid diamino silicone resin, the multi-functional amine, the epoxy resin, and the fumed silica to form a composition on the surface.

12. The method of claim 11, further comprising contacting the composition with a second surface.

13. The method of claim 9, further comprising a curing step after one or more of the liquid diamino silicone resin, the multi-functional amine, the epoxy resin, and the fumed silica are applied to the surface.

14. The method of claim 13, further comprising curing at a temperature of about 0° C. to about 10° C.

15. The method of claim 13, wherein an organic component is not released during and/or after the curing step.

16. The method of claim 9, further comprising applying a first mixture comprising the liquid diamino silicone resin and the multi-functional amine, subsequently applying the epoxy resin to form a second mixture, and subsequently applying the fumed silica to the second mixture to form a third mixture.

17. The method of claim 9, wherein the surface is submerged in an aqueous medium during the application step.

18. The method of claim 9, wherein the method excludes adding a Mannich base to the surface.

19. A method of manufacturing a composition, comprising:
mixing a liquid diamino silicone resin with an epoxy resin to form a first mixture,
mixing a multi-functional amine with an epoxy resin to form a second mixture, and
mixing the first mixture with the second mixture and fumed silica to form the composition.

20. The method of claim 19, further comprising reacting the composition with an epoxy resin component to form an adhesive composition.
